(19) United States
(12) Patent Application Publication
(10) Pub. No.: US 2026/0033583 A1
(43) Pub. Date: Feb. 5, 2026

(54) SYSTEM AND METHOD TO MANUFACTURE ARTICLES OF FOOTWEAR WITH ADDITIVE MANUFACTURING

(71) Applicants: Lucas Abia HOF, Longueuil (CA); Chahine GHIMOUZ, Montréal (CA); Julie TZENG, Brooklyn, NY (US)

(72) Inventors: Lucas Abia HOF, Longueuil (CA); Chahine GHIMOUZ, Montréal (CA); Julie TZENG, Brooklyn, NY (US)

(21) Appl. No.: 18/793,361

(22) Filed: Aug. 2, 2024

(51) Int. Cl. A43B 1/00; A43B 13/02; A43B 23/02; B33Y 80/00

(52) U.S. Cl. CPC A43B 1/00; A43B 13/02; A43B 23/0205; B33Y 80/00

(57) ABSTRACT

An article of footwear, has: an outsole for contacting a ground; an upper secured to the outsole; and a mid-sole between the outsole and the upper, the mid-sole and the upper conjointly defining a foot-receiving cavity for receiving a foot of a wearer, wherein one or more of the outsole, the upper, and the mid-sole includes: a lattice structure including a plurality of monolithically interconnected cells, the lattice structure having at least a first region and a second region each configured to overlap a respective area of the foot of the wearer, the first region having a first stiffness different than a second stiffness of the second region.

### TECHNICAL FIELD

The application relates generally to footwear and, more particularly, to additive manufacturing and systems to manufacture shoes with additive manufacturing.

### BACKGROUND

Existing shoe manufacturing techniques typically require a plethora of different materials assembled together using adhesive and/or stitching. These different materials are required since each part of a shoe has specific requirements. For instance, the upper has to be breathable and flexible to accommodate flexion of a foot. The sole has to be wear-resistant and shock absorbent. It is therefore a challenge to minimize materials involved in shoe manufacturing. Moreover, the global fashion industry is facing carbon footprint issues. Hence, although existing shoe manufacturing techniques are satisfactory to some extend, there is room for improvements.

### SUMMARY

Advanced additive manufacturing design capabilities may open the door for designers to create shoes with lattice structures, new aesthetics, flexibility, and support. This may optimize the life cycle of the product as a whole and may increase customer satisfaction. The present disclosure introduces technical schemes in the design of shoes for the purposes of topological optimization and use simulations in order to predict the mechanical performance of the product while retaining a personalized aesthetic appearance and reducing wastage due to falls and debris during production.

This disclosure explores how Design for Additive Manufacturing (DfAM), Design for Assembly (DfA), and Design for Disassembly (DfD) strategies, along with Additive Manufacturing's (AM) capability to produce intricate parts, can contribute to the fashion industry's shift towards a Circular Manufacturing model. The focus is on footwear manufacturing and its carbon footprint issues. The proposed additively manufactured shoe design may utilize Polyamide 12 and Thermoplastic polyurethane as feedstock, featuring a glueless mechanical assembly system based on a snap fit.

Notably, the upper part of the shoe incorporates a variable lattice structure to ensure flexibility in different areas. Finite Element Analysis (FEA) may be used to demonstrate that the snap fit assembly exceeds the industry standard's minimum disassembly force requirement. Additionally, an optimization algorithm for the variable lattice structure may result in a 34% mass reduction while maintaining the desired Young's modulus in each shoe region. This design approach may align with the footwear industry's sustainability goals, aiming to reduce environmental impact and enhance product durability. The study successfully developed a strategy to implement AM for sustainable shoe fabrication.

In one aspect, there is provided an article of footwear, comprising: an outsole for contacting a ground; an upper secured to the outsole; and a mid-sole between the outsole and the upper, the mid-sole and the upper conjointly defining a foot-receiving cavity for receiving a foot of a wearer, wherein one or more of the outsole, the upper, and the mid-sole includes: a lattice structure including a plurality of monolithically interconnected cells, the lattice structure having at least a first region and a second region each configured to overlap a respective area of the foot of the wearer, the first region having a first stiffness different than a second stiffness of the second region.

The article of footwear described above may include any of the following features, in any combinations.

In some embodiments, the plurality of interconnected cells include one or more of gyroid cells, schwarz cells, diamond cells, lidinoid cells, splitp cells, neovius cells, strut-based cells, skeletal-TPBS based cells, sheet-TPBS based cells, periodic cells, non-periodic cells, stochastic cells.

In some embodiments, the plurality of interconnected cells are sheet-based (TPMS) diamond cells.

In some embodiments, a transition region is located between the first region and the second region, a stiffness in the transition region varying from the first stiffness to the second stiffness.

In some embodiments, a stiffness gradient in the transition region is different than 0.

In some embodiments, each of the plurality of interconnect cells has a height, a width, a depth, and interconnected walls having a thickness, cells of the first region differ from cells in the second region by one or more of the height, the width, the depth, and the thickness.

In some embodiments, a cell of the plurality of interconnect cells is characterized by a volume ratio corresponding to a volume of the cell occupied by a solid material to a total volume of the cell, cells of the first region differ from cells in the second region by their volume ratios.

In some embodiments, the one or more of the outsole, the upper, and the mid-sole is the upper.

In some embodiments, the first region is one or more of a tip section of the outsole and a heel section of the outsole and the second region is a part of the outsole located between the tip section and the heel section, the first stiffness higher than the second stiffness.

In some embodiments, an insole is inside the foot-receiving cavity, the insole made with the lattice structure.

In another aspect, there is provided a method for manufacturing an article of footwear, comprising: receiving design parameters of one or more of an outsole, an insole, a mid-sole, and an upper of the article of footwear, the design parameters including, for each of the one or more of the outsole, the mid-sole, the insole, and the upper, regions of the article of footwear and respective stiffness values associated with the regions; determining parameters of cells of a lattice structure to achieve the stiffness values; and manufacturing the one or more of the outsole, the mid-sole, and the upper of the article of footwear by creating the lattice structure with an additive manufacturing method using the parameters of the cells.

The method described above may include any of the following features, in any combinations.

In some embodiments, the receiving of the design parameters includes receiving Shore A hardness values associated with the regions.

In some embodiments, the method includes translating the Shore A hardness values to Young's moduli values.

In some embodiments, the translating of the Shore A hardness values to the Young's moduli values includes translating the Shore A hardness values with:

$$( 3 {F}_{0} ( 1 + {MiS}_{A} ) / ( 1 - {S}_{A} ) ) / 8 {p}_{0} r , where$$

$$Mi = {kp}_{0} / σ {F}_{0} ,$$

and

F₀=0.55 Newton, p₀=0.25 cm, r=0.0395 cm, and k is a stiffness constant of a spring mounted inside a durometer used to determine the Shore A hardness values.

In some embodiments, the manufacturing of the article of footwear by creating the lattice structure with the additive manufacturing method includes manufacturing the lattice structure with Laser-Beam Powder Bed Fusion (LB-PBF), material jetting, or vat-photopolymerization.

In some embodiments, the determining of the parameters of the cells includes, for each of the regions, determining one or more of a type of cell, a thickness of walls of the cell, a size of the cell, and a cell orientation.

In some embodiments, the method includes determining volume ratios of the cells, a volume ratio corresponding to a volume of the cell occupied by a solid material to a total volume of the cell.

In some embodiments, the method includes homogenizing the lattice structure.

In some embodiments, the homogenizing of the lattice structure includes determining parameters of transition cells located at transition regions located between two regions of different stiffness.

In some embodiments, the cells are sheet-based (TPMS) diamond cells.

### BRIEF DESCRIPTION OF THE DRAWINGS

Reference is now made to the accompanying figures in which:

FIG. 1 is a three-dimensional exploded view of a shoe in accordance with one embodiment;

FIG. 2 is a schematic view of a shoe manufacturing system in accordance with one embodiment;

FIG. 3A is a three-dimensional view of a cell of a lattice structure used for the shoe of FIG. 1;

FIG. 3B is a three-dimensional view of another possible cell for the lattice structure of the shoe;

FIG. 4 is a three-dimensional view of an upper for a shoe made with the lattice structure of FIG. 3B and the system of FIG. 2;

FIG. 5 is a flowchart illustrating steps of a method of manufacturing the shoe of FIG. 1;

FIG. 6A is a cut-away view of the shoe of FIG. 1 illustrating a fastening mechanism thereof;

FIG. 6B is a three-dimensional view of the fastening mechanism of FIG. 6A;

FIG. 6C is a three-dimensional view of a connector of the fastening mechanism of FIG. 6; and

FIG. 7 is a schematic representation of a data processor in accordance with one embodiment.

### DETAILED DESCRIPTION

### Introduction

The global consumption of natural resources is constantly increasing. The corresponding human activity is progressively emitting anthropogenic greenhouse gases (GHG) each year, exceeding 48.9 giga tons of CO2 equivalent (CO2-eq) in 2018 as reported by Climate Watch Dat. From these annual GHG emissions, an amount of 1.7 giga tons of CO2-eq were emitted only by the textile and footwear industry in 2015 and if this trend continues. As well, the waste generation from the clothing and footwear industry is projected to increase from 92 mega tons in 2015 to 148 mega tons in 2030. In addition, only 5% of footwear is recycled globally, which results in sustainability issues for this industry.

This acceleration of raw material consumption and GHG emissions in the manufacturing industry is partly due to the actual typical linear economic model (Take, Make, Use and Throw), also referred to as the “linear economy” (LE). To address this issue of overconsumption and the environmental challenge that the planet is experiencing, a more sustainable model has been proposed; the “circular economy” (CE). This approach presents the economy as a business mindset that will enable a shift towards long-term sustainable development including a principle concept based on the 6Rs (Reuse, Recycle, Redesign, Remanufacture, Reduce, and Recover). Based on these developments, the “circular manufacturing” (CM) model is emerging as one of the engineering solutions to consider for sustainable production. In such a CM model, the product design, used materials, and its manufacture play an essential role in the product's recyclability. More specifically, a “circular design” process includes rethinking the product design not only for its end-use, but also for its user environment and process steps at its end-of-life (EOL) state to favor reuse, facilitating its reinsertion in a closed manufacturing loop and ultimately disassembly for improved recyclability.

In such circular manufacturing systems, design for assembly (DfA) and design for disassembly (DfD) strategies are key methodological elements for product and process development aimed at reducing costs and improving reliability without changing product function. These DfA and DfD approaches are based on some specific design principles including: reduce the number of parts; simplify the design; design for easy assembly and disassembly; design for efficient joining and fastening; minimize flexible parts and interconnections; standardize parts and materials; and design modular products.

Additive manufacturing (AM), or 3D printing, which is a relatively new technology, has an interesting potential for circular manufacturing, by reducing waste, energy consumption and manufacturing costs at small production scales. It may also facilitate reuse by creating parts in modular designs that facilitate their reuse and repair. In addition, AM may enable the development of sustainable products by considering sustainable and circular development principles from the beginning of the design process. This can result in products that are more sustainable and easily recyclable or reusable at the end of their life.

In 2019, a record-year regarding the volume of produced footwear, 24.3 billion pairs were produced and sold or more than 65 million pairs of shoes per day. However, footwear manufacturing is a labor-intensive process, as typical footwear products consist of 65 individual parts including around 360, mostly manual, manufacturing steps. This traditional manufacturing approach is still highly labor and machine intensive for footwear part production and final product assembly. Additive manufacturing may offer a promising alternative that may allow footwear manufacturers to streamline the production of certain shoe components.

### Anatomy of a Shoe

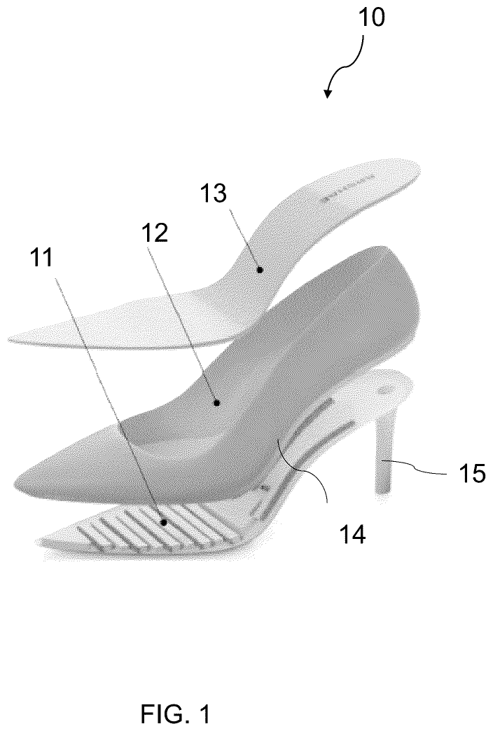

Referring to FIG. 1, a shoe is shown at 10. It will be appreciated that the present disclosure applies to any article of footwear such as, for instance, boots, sandals, shoes, and so on. The shoe 10 includes an outsole 11 configured for contacting a ground. The outsole 11 may be made of a wear-resistant material and may define ribs, grooves, and so on to provide traction on the ground. In some embodiments, the outsole 11 may be substantially flat depending on the kind of shoe. The shoe 10 includes an upper 12 secured to the outsole 11. The upper 12 cooperates with the outsole 11 in defining a foot-receiving cavity for receiving a foot of a wearer. The upper overlaps a top portion of the foot of the wearer. The shoe 10 may include an insole 13 providing a cushioning layer to the wearer. The foot of the wearer may thus contact the insole 13. A mid-sole 14 may be embedded in the shoe between the upper 12 and the outsole 11. The mid-sole 14 may provide different properties to the shoe depending of its use. For instance, the mid-sole 14 may provide dampening in case of a running shoe. As will be described below, the present disclosure uses additive manufacturing to manufacture one or more parts of the shoe 10. In this embodiment, the shoe 10 is a high-heel and includes a heel 15. However, the principles of the present disclosure apply to any kind of shoes.

### Additive Manufacturing

Compared to conventional polymer manufacturing processes, such as injection molding, thermoforming, or extrusion, additive manufacturing (AM), or 3D printing, is a relatively new manufacturing process. Among the seven AM technologies defined in the ISO/ASTM 52900:21 standard, powder bed fusion (PBF) of polyamide 12 (Nylon 12 or PA12) is considered as the most mature technology for industrial product applications. The most widely used AM technologies for PBF are Multi Jet Fusion (MJF) and Selective Laser Sintering (SLS). SLS uses a laser to melt and fuse the feedstock powder, while MJF uses a bonding agent, heat and infrared light to fuse the powder to create the final object. Both technologies involve heating of feedstock powder particles, with typical size between 45 and 90 μm, to sinter and consolidate the particles layer by layer to form a three-dimensional (3D) object. Compared to conventional manufacturing, AM provides high geometric freedom in design and fabrication. In addition, PBF AM processes facilitate product manufacturing for mass customization, weight reduction, surface texturing and dimensional accuracy. Reducing the number of different types of material is interesting for circular design and manufacturing strategies, as it may facilitate the product disassembly and recycling processes at a product's EOL. Any suitable additive manufacturing methods, such as laser-beam powder bed fusion (LB-PBF), selective laser sintering (SLS), material jetting, vat photopolymerization, and so on may be used.

### Architectured Materials

Natural cellular materials such as wood, cork or bone have been well used for centuries, and their structure is imitated in modern engineering materials such as honeycombs and foams to take advantage of their specific mechanical properties due to their porosity. This bio-inspired engineering field opens up many new possibilities, resulting in the creation of architectured materials such as lattice structures. AM and more specifically LB-PBF (e.g., SLS) may be well suited for the fabrication of such structures. Lattice structures are three-dimensional periodic arrangements of a unit cell resulting in a coherent and homogeneous material with specific mechanical and thermal properties. The type of unit cell can be divided into three main classes, which are 1) strut-based lattices, 2) planar lattices, and 3) surface-based lattices, where each category demonstrates different mechanical behavior.

The control of the lattice structures' mechanical properties depends strongly on its class as well as on its type, such as diamond, gyroid or other. The structure may deform with a combination of bending, torsion or stretching of the lattice struts. The mechanical properties' dependence on the structure's density is impacted by the loading mode it is exposed to. In fact, the sheet type Triply Periodic Minimal Surface (TPMS), belonging to the surface-based lattices class, depends the least on its relative density and it has the highest modulus of elasticity and mechanical strength for the same density compared to the other classes. Hence, this sheet TPMS surface-based lattice type provides a large design space to control the mechanical properties of the architected material. Therefore, this lattice type and class may be used for shoe manufacturing as will be shown below.

This disclosure presents a circular manufacturing approach for footwear manufacturing using additive manufacturing (AM) techniques to increase their remanufacturability and recyclability by focusing on a design for disassembly. AM offers new design possibilities that are exploited in the developed production strategy to reduce the number of footwear parts and to achieve glue-less component assembly, which favors disassembly for remanufacturing and recycling when reaching the end-of-life stage of the shoes.

The prototype design considered to the integration of key footwear parts to maintain functional parts that will be used in the assembly; the outsole, insole, the mid-sole, and the upper as shown in FIG. 1. The outsole will be subjected to the load distribution applied to the shoe due to a user's weight and therefore it must be able to withstand this load with a specified safety factor. The insole must have a certain amount of flexibility (low stiffness) to ensure the users' comfort when wearing the shoe. Similarly, the upper-being in direct contact with the skin and having the role of containing the foot-needs to have a specific stiffness to ensure the comfort of the shoe while keeping a certain resistance to tearing.

### Manufacturing System

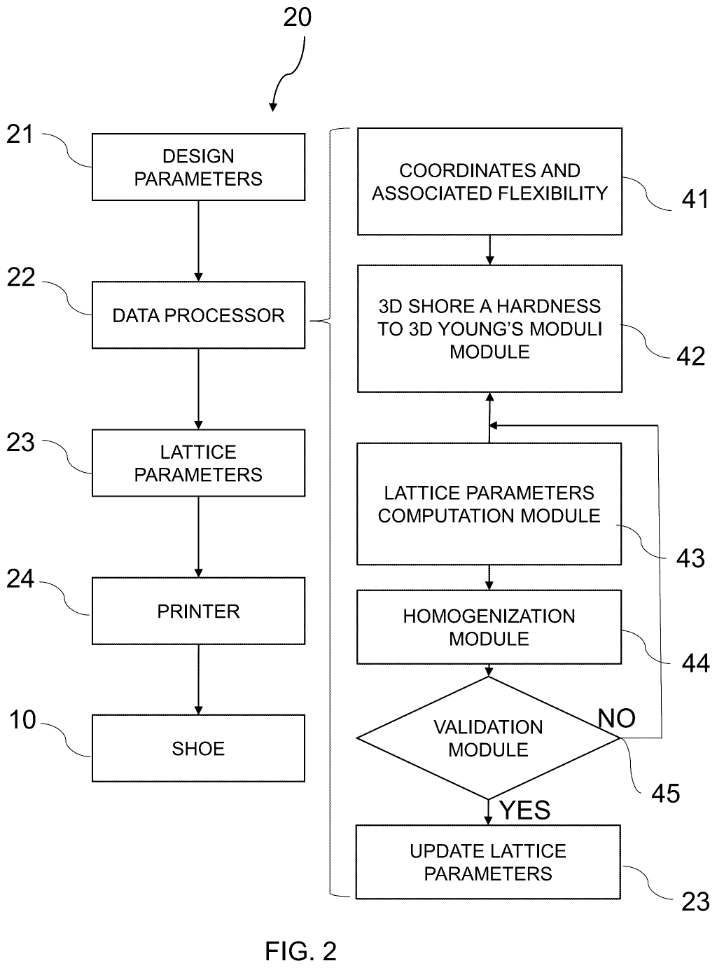

Referring now to FIG. 2, a system for manufacturing a shoe is shown at 20. The system 20 uses additive manufacturing to manufacture one or more parts of the shoe. The one or more parts may include any of the outsole 11, the upper 12, the insole 13, the mid-sole 14, and the heel 15. The system 20 uses design parameters 21 of the shoe 10 that are fed to a data processor 22 that computes lattice parameters 23 that are used to manufacture the one or more parts of the shoe with an additive manufacturing device, labelled as “printer 24” in FIG. 2, to yield the shoe at 10.

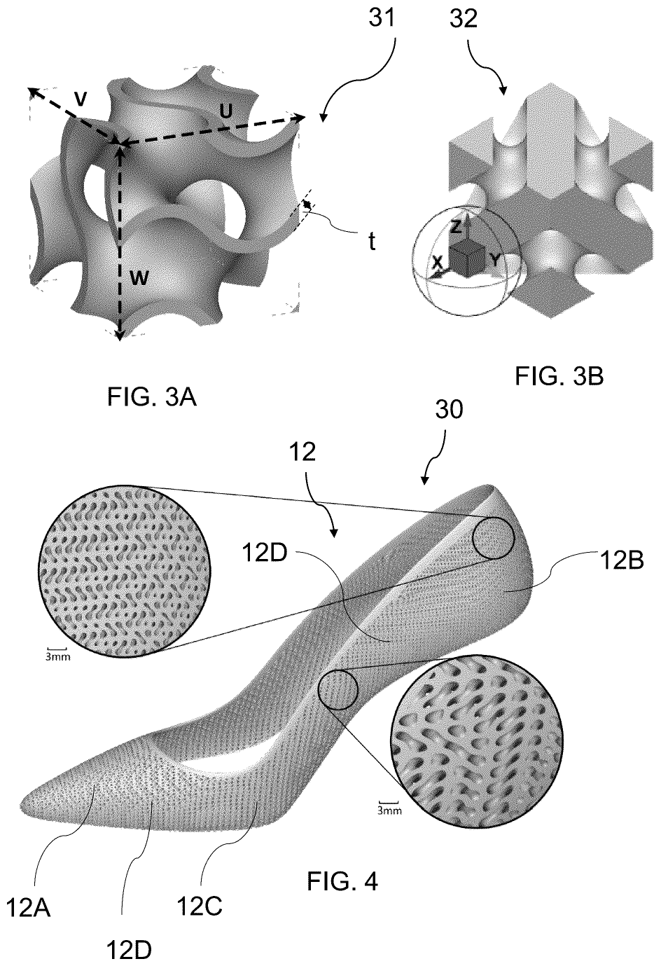

Referring to FIGS. 3A, 3B, and 4, the one or more of the parts of the shoe is/are made of a lattice structure 30 that includes cells 31 or cells 32. The lattice structure 30 includes a plurality of the cells 32 interconnected to one another. The lattice structure 30 may be a single monolithic part. In other words, the lattice structure includes a plurality of monolithically interconnected cells.

FIG. 3A illustrates the cell 31 being a gyroid, but other types of cells, such as schwarz, diamond, lidioid, splitp, neovius, and so on may be used. For instance, FIG. 3B illustrates another kind of cell, referred to as a diamond cell, that may be used. In some cases, the lattice structure 30 may include a plurality of different types of cells. Diamond cells may provide the largest stiffness range compared to other cell types, however other cell types may be used too.

The cells used for the lattice structure 30 may be strut-based cells, such as Kelvin, Octet-truss, Gibson-Ashby, they may be skeletal-TPMS based cells, such as skeletal-IWP, skeletal-Diamond, skeletal-Gyroid, and they may be sheet-TPMS based cells, such as sheet-IWP, sheet-Diamond, sheet-Gyroid, and sheet-Primitive. Other types of cells may be used. For instance, honeycomb and stochastic lattices may be used. Periodic or non-periodic lattice structures may be used. Periodic structures include planar-based, strut-based, and surface-based structure while non-periodic structures include stochastic structures.

The lattice structure 30 may present variations in stiffnesses in all directions (e.g., x, y, z). Put differently, a stiffness gradient may be present across a thickness of the lattice structure 30 and along two directions parallel to the lattice structure; the two directions being perpendicular to one another.

Referring more particularly to FIG. 3A, the cell 31, a gyroid cell in this embodiment, is a three-dimensional shape that is both periodic and non-self-intersecting. It is a triply periodic minimal surface (TPMS). The cell 31 may be characterized by many parameters, such as its wall thickness t, its height W, its width U, and its depth V. A cell orientation may be another parameter considered. The thickness t may range from about 0.06 to about 0.1 mm, its height W, width U, and depth V may be equal to one another and range from about 2 to about 5 mm. In the context of the present disclosure, the expression “about” implies variations of plus or minus 10%.

Referring more particularly to FIG. 4, the lattice structure 30 for the upper 12 of the shoe is shown. In this embodiment, the lattice structure 30 is made using sheet-based (TPMS) diamond cells 32, but it may alternatively be made using any suitable cells. The upper 12 has different regions differing by their flexibility to provide adequate comfort for the wearer. In the shoe industry, the design parameters 21 used for the shoe correspond to the Shore A hardness values at different regions. For instance, a toe region 12A may have a Shore A hardness of from 60 to 65, a heel region 12B of the upper 12 may have a Shore A hardness of from 75 to 80, a mid-foot region 12C may have a Shore A hardness of from 40 to 64 while the outsole of the shoe may have a Shore A hardness of from 60 to 100. Moreover, the upper 12 has transition regions 12D between each adjacent regions. In those transition regions, a hardness or stiffness gradient is present to gradually vary the stiffness from the stiffness of one of the regions to that of the adjacent region. In other words, the lattice structure 30 of the upper 12 includes a plurality of the cells 31 interconnected to one another and has at least two regions different from one another by their respective stiffness. The transition regions 12D define a stiffness gradient different than 0. In the transition regions 12D, the stiffness varies (e.g., linearly) between stiffness values of two adjacent regions.

To vary the stiffness, one or more of the depth V, width U, height W, wall thickness t of the cell 31, and a volume ratio may be varied. The volume ratio corresponds to a volume of the cell 31 occupied by a solid material to a total volume of the cell (e.g., depth times width times height). The volume ratio may be different between the different regions of the shoe and may vary within a transition region.

Referring back to FIG. 2, the system 20 receives design parameters 21 of the shoe. The design parameters 21 are typically provided by shoe designer and include Shore A hardness as a function of locations on the shoe. For instance, the design parameters 21 may include a list of different locations on the shoe and associated required Shore A hardness. These design parameters 21 are then fed to the data processor 22, which may be computer, controller, etc, used to translate those design parameters 21 into the lattice parameters 23 used to manufacture the one or more parts of the shoe using the printer 24 to obtain the shoe 10.

The data processor 22 include a plurality of modules. The system 20 creates a list of coordinates and associated flexibility 41 (e.g., Shore A hardness). In some embodiments, the list of coordinates and associated flexibility may be obtained from a 3D scan of a foot, which may provide sufficient information to determine the stresses induced by the shoe. With the expertise of a designer, the stresses can be translated into Shore A hardness at any point around the foot. This may be automated. The coordinates include a plurality of locations on the one or more parts of the shoe. The method 40 then translates the Shore A hardness received from the shoe designer into Young's moduli via a Shore A hardness to Young's moduli module 42. As explained below, many methods may be used to perform this translation. The Young's moduli obtained are then used to compute lattice parameters via a lattice parameter computation module 43. The lattice parameters computation module 43 therefore determines parameters of the cells 31 of the lattice structure 30 to meet the flexibility requirements at each location on the one or more parts of the shoe. The system 20 then goes to a homogenization module 44. The homogenization module 44 modifies the cell parameters to ensure a smooth transition between the different regions of varying stiffness/flexibility. The homogenization module 44 may then compute the three-dimensional effective Young's moduli of the lattice structure at each point. These values are then fed to a validation module 45. The validation module 45 determines if the updated lattice parameters meet the flexibility/stiffness requirements. If so, the lattice parameters 23 are outputted from the data processor 22 and used to feed the printer 24. However, if the lattice parameters do not meet the requirements, the system 20 loops back to the lattice parameters computation module 43 to modify the lattice parameters until the lattice parameters meet the requirements for stiffness/flexibility.

### Printing Material and Technology

Based on their mechanical properties (see Table below), two materials were selected in the developed footwear concept: polyamide 12 (also called nylon 12 or PA12) and a thermoplastic polyurethane (TPU). The nylon 12 material PA2200 from EOS™ was selected for the outsole and the thermoplastic polyurethane LUVOSINT TPU X92A-1 NT™ from LEHVOSS Group for the upper part and the insole. Understandably, other materials are contemplated. For instance, for the upper part and the insole any material that has Shore A hardness between 70 and 90 may be used (typically thermoplastic elastomers will be selected for these parts). The outsole may be printed in Nylon 11 also. The Nylon can be filled with carbon or glass fibers for more rigidity. Thermoplastic materials may be selected for recycling purposes.

| | Tensile | Young modulus | Elongation at |
|---|---|---|---|
| Materials | Strength (MPa) | (MPa) | break (%) |
| PA2200 | 46 | 1650 | 18 |
| LUVOSINT TPU | 20 | 92* | 520 |
| X92A-1 NT | | | |

*Shore hardness A.

The orientation of the LB-PBF printing may be done in a lateral XY plane and 100% virgin powder may be used as feedstock or suitable mixed virgin/used feedstock ratios can be deployed for printing the parts. The printed part may undergo a chemical surface treatment by vapor polishing.

### Conversion of Shoe A hardness to Young's Modulus

Different methods are possible to translate a Shore A hardness to a Young's modulus via the Shore A hardness to Young's moduli module 42:

$$[ Gent Function ] Y = ( 0.0981 ( 56 + 7.62336 {S}_{A} ) ) / ( 0.137505 ( 254 - 2.54 {S}_{A} ) ) )$$

$$[ Ruess Function ] Y = {10}^{0.0235 {S}_{A} - 0.6403}$$

$$[ Error Function ] {S}_{A} = 100 erf ( 3.186 {10}^{- 4} \sqrt{Y} )$$

$$[ Mix \& Giacomin ] Y = ( 3 {F}_{0} ( 1 + {MiS}_{A} ) / ( 1 - {S}_{A} ) ) / 8 {p}_{0} r$$

The table below shows Young's moduli equivalent to different Shore A hardness for each of the above listed methods:

| | | Gent | Reuss | Error | Mix and |
|---|---|---|---|---|---|
| | Shore | function | function | function | Giacomin |
| Areas | A | (MPa) | (MPa) | (MPa) | Method (MPa) |
| 1 | 60-65 | 3.6-4.42 | 5.88-7.71 | 3.48-4.3 | 4.79-5.88 |
| 2 | 75-80 | 7.05-9.35 | 13.24-17.36 | 6.5-8.09 | 9.38-12.43 |
| 3 | 55-65 | 2.96-4.42 | 4.48-7.71 | 2.81-4.3 | 3.94-5.88 |
| 4 | 40-55 | 1.68-2.98 | 1.99 4.48 | 1.35-2.81 | 2.24-3.94 |

In the above equations SA represents the Shore A hardness indicated by a durometer according to ASTM D2240-05, Y is the Young's modulus, Mi is the mechanical identability calculated as:

$$Mi = {kp}_{0} / σ {F}_{0}$$

Where k is the stiffness constant of the spring mounted inside the durometer, and the constants F₀, p₀, and r equal the values of 0.55 N, 0.25 cm, and 0.0395 cm, respectively. In this embodiment, the method of Mix and Giacomin was elected.

As described above, to create a lattice structure for the upper, or other parts, of the shoe, an optimization algorithm may be used. The nTop™ platform via nTopcl™ may be used as tools for creating lattice structures. These tools may be embedded into the lattice parameters computation module 43 and the homogenization module 44. The design may be based on the Triply Periodic Minimal Surface (TPMS) type, which may be the most appropriate lattice type for small thickness structures. The material properties were determined using the numerical homogenization method, which involved applying boundary conditions on a finite element model representing a unit cell in a periodic structure. The homogenized elastic properties of the material are calculated from the displacement fields associated with six-unit strain loads in the X, Y, Z, XY, YZ, ZX directions under periodic boundary conditions. The nTop platform may allow to test the elastic response of each created unit cell and it may enable to determine the stiffness tensor of the structure according to the different directions in the form of a 6×6 sized matrix, using the generalized Hooke's law σij=Cᵢⱼₖₗεₖₗ, where σᵢⱼ, εₖₗ, and Cᵢⱼₖₗ are the components of the Stress, strain and stiffness tensor respectively, which we can be represented as follows using Voigt's notation:

$$( \begin{matrix}{σ}_{1} \\ {σ}_{2} \\ {σ}_{3} \\ {σ}_{4} \\ {σ}_{5} \\ {σ}_{6}\end{matrix} ) = [ \begin{matrix}{c}_{11} & {c}_{12} & {c}_{13} & {c}_{14} & {c}_{15} & {c}_{16} \\ {c}_{21} & {c}_{22} & {c}_{23} & {c}_{24} & {c}_{25} & {c}_{26} \\ {c}_{31} & {c}_{32} & {c}_{33} & {c}_{34} & {c}_{35} & {c}_{36} \\ {c}_{41} & {c}_{42} & {c}_{43} & {c}_{44} & {c}_{45} & {c}_{46} \\ {c}_{51} & {c}_{52} & {c}_{53} & {c}_{54} & {c}_{55} & {c}_{56} \\ {c}_{61} & {c}_{62} & {c}_{63} & {c}_{64} & {c}_{65} & {c}_{66}\end{matrix} ] ( \begin{matrix}{ε}_{1} \\ {ε}_{2} \\ {ε}_{3} \\ {ε}_{4} \\ {ε}_{5} \\ {ε}_{6}\end{matrix} )$$

In the case of cubic elasticity, the stress is written as shown in the equation below. Then, the following relations for the stiffness tensor components are deployed: C₁₁=C₂₂=C₃₃, C₁₂=C₂₁=C₁₃=C₃₁=C₂₃=C₃₂, C₄₄=C₅₅=C₆₆, and the rest of the components are equal to zero:

$$( \begin{matrix}{σ}_{1} \\ {σ}_{2} \\ {σ}_{3} \\ {σ}_{4} \\ {σ}_{5} \\ {σ}_{6}\end{matrix} ) = [ \begin{matrix}{c}_{11} & {c}_{12} & {c}_{12} & 0 & 0 & 0 \\ {c}_{12} & {c}_{11} & {c}_{12} & 0 & 0 & 0 \\ {c}_{12} & {c}_{12} & {c}_{11} & 0 & 0 & 0 \\ 0 & 0 & 0 & {c}_{44} & 0 & 0 \\ 0 & 0 & 0 & 0 & {c}_{44} & 0 \\ 0 & 0 & 0 & 0 & 0 & {c}_{44}\end{matrix} ] ( \begin{matrix}{ε}_{1} \\ {ε}_{2} \\ {ε}_{3} \\ {ε}_{4} \\ {ε}_{5} \\ {ε}_{6}\end{matrix} )$$

To obtain the shear coefficient G and the Poisson ratio v from the compliance tensor S, it is necessary to invert the stiffness tensor using ε=C⁻¹σ and C⁻¹=S. The compliance tensor can then be presented by:

$$S = [ \begin{matrix}1 / Y & - v / Y & - v / Y & 0 & 0 & 0 \\ - v / Y & 1 / Y & - v / Y & 0 & 0 & 0 \\ - v / Y & - v / Y & 1 / Y & 0 & 0 & 0 \\ 0 & 0 & 0 & 1 / G & 0 & 0 \\ 0 & 0 & 0 & 0 & 1 / G & 0 \\ 0 & 0 & 0 & 0 & 0 & 1 / G\end{matrix} ]$$

$$With$$

$$G = \frac{Y}{2 ( 1 + v )}$$

Here, Y is the Young's modulus, v is the Poisson's ratio and G is one of the shear coefficients.

The chosen independent variables are the type of unit cell, the thickness of the cell walls, and the dimensions of the box containing the cell. The algorithm implemented for the creation of the optimized model of the lattice structure that meets the given constraints (Young modulus) at each point of the shoe. FIG. 2, described above, illustrates the implemented workflow to achieve this design optimization goal, which consist of two phases. The automatic phase includes an optimization program (e.g., with the different modules) that has the coordinates of a point cloud and the associated target as input, and the output of this program consists of the values of the independent variables that allowed us to reach the targeted effective Young's module (Y*). The manual phase consists in creating a mesh of the model with the requested mesh quality (noting that the gradual transition of unit cell geometric parameters between the regions depends greatly on the size of the chosen mesh) and subsequently extracting the point cloud that corresponds to the nodes of the mesh. After the automatic phase, the results of the topological optimization may be implemented to the point cloud using the “Ramp bloc” function on the nTop platform to obtain a gradual evolution of the dimensions of the unit cells in order to obtain a more refined and aesthetical final model and product.

Referring to FIG. 4, the lattice structure 30 for the upper 12 of the shoe 10 is shown. As illustrated, the volume ratio is different at the heel region 12B compared to at the mid-foot region 12C. Also, the wall thickness t is greater at the mid-foot region 12C than at the heel region 12B. More specifically, the volume ratio is greater at the heel region 12B than at the mid-foot region 12C. This may permit the mid-foot region 12C to have a greater flexibility, and lower stiffness, than the heel region 12B to permit the shoe to bend following movements of the foot of the wearer while walking.

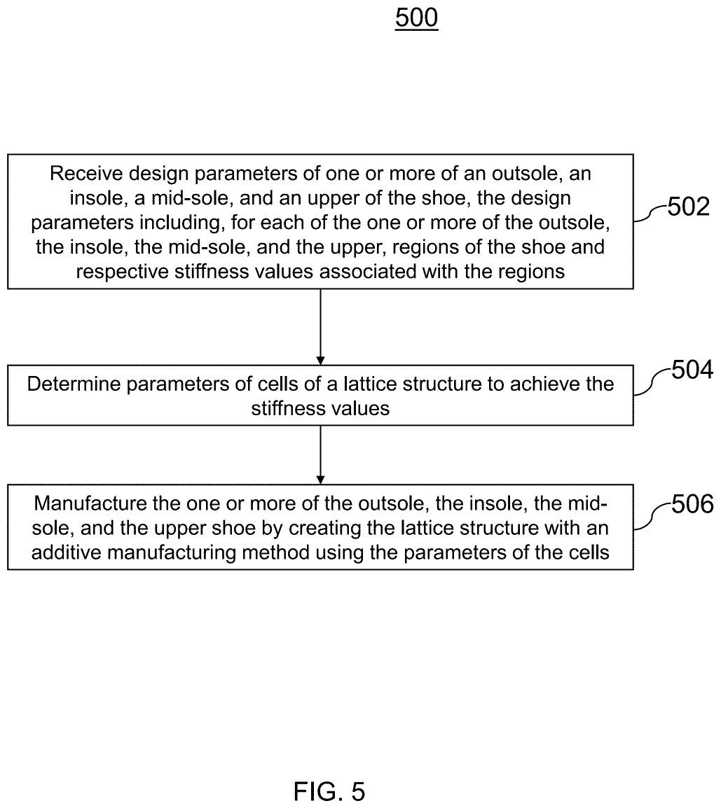

Referring now to FIG. 5, a method for manufacturing one or more part of the shoe 10 is shown at 500. The method 500 may be performed by the system 20 described above with reference to FIG. 2. The method 500 includes receiving design parameters of one or more of the outsole 11, the mid-sole 14, the insole 13, and the upper 12 of the shoe 10 at 502. As explained above, the design parameters include regions of the shoe and respective stiffness values associated with the regions. Then, the parameters of the cells 31 of the lattice structure 30 are determined to achieve the desired stiffness values at 504. The one or more of the outsole 11, the mid-sole 14, the insole 13, and the upper 12 of the shoe 10 may then be manufactured by creating a respective lattice structure 30 with the additive manufacturing method using the parameters of the cells 31 at 506.

In some embodiments, the receiving of the design parameters at 502 includes receiving Shore A hardness values associated with the regions. The method 500 may include translating the Shore A hardness values to Young's moduli values. This may be done using any of the equations described above.

In some embodiments, the manufacturing of the shoe 10 at 506 by creating the lattice structure 30 with the additive manufacturing method includes manufacturing the lattice structure with selective laser sintering.

In some embodiments, the determining of the parameters of the cells at 504 includes, for each of the regions, determining one or more of a type of cell, a thickness of walls of the cell, a size of the cell. It may include determining the volume ratios of the cells 31.

In some embodiments, the method 500 includes homogenizing the lattice structure 30. This may be done by determining parameters of transition cells located at the transition regions located between two regions of different stiffness.

In some embodiments, the manufacturing at 506 may include manufacturing the part(s) of the shoe 10 with thermoplastic polyurethane. Other suitable materials may be used as mentioned above.

### Mechanical Assembly

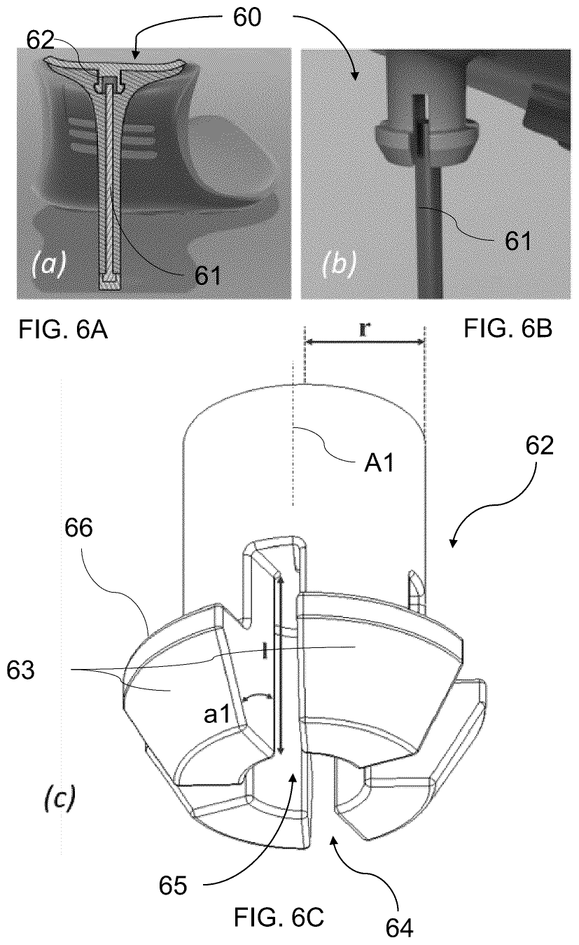

To achieve footwear disassembly for complete repurposing (remanufacturing or recycling) at its end-of-life, it may be desired to eliminate the use of chemical glue during the shoe assembly process. Avoiding the use of glue may facilitate footwear parts disassembly for their individual recycling. Referring to FIGS. 6A-6C, a mechanical assembly system is shown at 60 and is used to replace chemical connections. The assembly system 60 may use a snap fit connection to assemble, for instance, the upper 12 of the shoe 10 and the outsole 11 as shown in FIG. 6A. The system 60 may include an elongated member 61, which may be made of aluminum or steel, inserted into the heel 15 to increase the lateral impact resistance. The system 60 includes a connector 62, which may be secured to the outsole 11. The connector 62 includes four legs 63, although more or less than four legs may be used, circumferentially distributed about a central axis A1. Each of the four legs are spaced apart from one another by a slot 64. The connector 62 defines a central aperture 65 for receiving the elongated member 61. The four legs 63 each define a shoulder 66 to create a retention surface.

As shown in FIG. 6A, the connector 62 is embedded into the heel 15 once the heel 15 is secured to the outsole 11. The retention of the heel 15 to the outsole 11 is provided by the shoulders 66 of the legs 63 of the connector 62. The legs 63 are shaped like an anchor to secure the heel 15 to the outsole 11. The legs 63 may deflect radially inwardly towards the central axis A1 once the elongated member 61 has been removed during disassembly. The elongated member 61 stays in place during usage since it contributes to avoid any deflection of the legs during usage. Therefore, to disassemble the shoe 10, the elongated member 61 may be withdrawn from the heel 15, which allows the legs 63 to deflect inwardly thereby permitting the disconnection of the heel 15 from the outsole 11. Thus, a connection between the heel 15 and the outsole 11 may be devoid of glue or other adhesive/fastener. To assemble the heel 15 to the outsole 11, one may insert the connector 62 into a correspondingly-shaped cavity of the heel 15 until the legs 63 snap into place and in which the shoulders 66 are in abutment against an internal face of the heel 15. Then, the elongated member 61 may be inserted in the heel 15 until it is received in to the centra aperture 65 of the connector 62 thereby preventing the deflection of the legs 63 and, thus, locking the heel 15 to the outsole 11. Dimensions of the legs, such as the angle a1 and the length l may be adjusted to obtain the desired stiffness.

The disclosed shoe and method of manufacturing thereof may reduce materials used and may thus me more environmentally friendly, may facilitate recycling of the worn-out shoes since less materials are involved in their manufacturing, and may permit personalization of the shoes.

### Controller

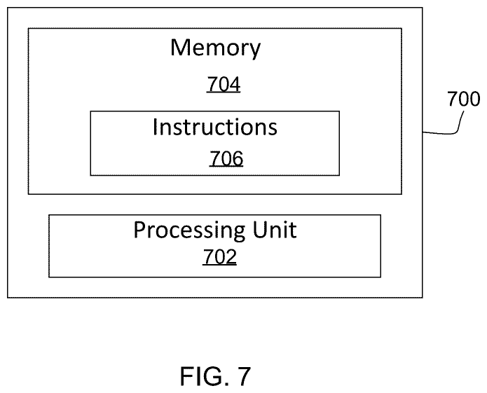

With reference to FIG. 7, an example of a computing device 700 is illustrated. For simplicity only one computing device 700 is shown but the system may include more computing devices 700 operable to exchange data. The computing devices 700 may be the same or different types of devices. The data processor 22 may be implemented with one or more computing devices 700.

The computing device 700 comprises a processing unit 702 and a memory 704 which has stored therein computer-executable instructions 706. The processing unit 702 may comprise any suitable devices configured to implement the method described herein, when executed by the computing device 700 or other programmable apparatus, may cause the functions/acts/steps performed as part of the method as described herein to be executed. The processing unit 702 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 704 may comprise any suitable known or other machine-readable storage medium. The memory 704 may comprise non-transitory computer readable storage medium, for example, but not limited to, an electronic, magnetic, optical, electromagnetic, infrared, or semiconductor system, apparatus, or device, or any suitable combination of the foregoing. The memory 704 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 704 may comprise any storage means (e.g., devices) suitable for retrievably storing machine-readable instructions 706 executable by processing unit 702.

The methods and systems described herein may be implemented in a high level procedural or object oriented programming or scripting language, or a combination thereof, to communicate with or assist in the operation of a computer system, for example the computing device 700. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 702 of the computing device 700, to operate in a specific and predefined manner to perform the functions described herein, for example those described in the method described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An article of footwear, comprising:
an outsole for contacting a ground;
an upper secured to the outsole; and
a mid-sole between the outsole and the upper, the mid-sole and the upper conjointly defining a foot-receiving cavity for receiving a foot of a wearer,
wherein one or more of the outsole, the upper, and the mid-sole includes:
a lattice structure including a plurality of monolithically interconnected cells, the lattice structure having at least a first region and a second region each configured to overlap a respective area of the foot of the wearer, the first region having a first stiffness different than a second stiffness of the second region.

2. The article of footwear of claim 1, wherein the plurality of interconnected cells include one or more of gyroid cells, schwarz cells, diamond cells, lidinoid cells, splitp cells, neovius cells, strut-based cells, skeletal-TPBS based cells, sheet-TPBS based cells, periodic cells, non-periodic cells, stochastic cells.

3. The article of footwear of claim 2, wherein the plurality of interconnected cells are sheet-based (TPMS) diamond cells.

4. The article of footwear of claim 1, comprising a transition region between the first region and the second region, a stiffness in the transition region varying from the first stiffness to the second stiffness.

5. The article of footwear of claim 4, wherein a stiffness gradient in the transition region is different than 0.

6. The article of footwear of claim 1, wherein each of the plurality of interconnect cells has a height, a width, a depth, and interconnected walls having a thickness, cells of the first region differ from cells in the second region by one or more of the height, the width, the depth, and the thickness.

7. The article of footwear of claim 1, wherein a cell of the plurality of interconnect cells is characterized by a volume ratio corresponding to a volume of the cell occupied by a solid material to a total volume of the cell, cells of the first region differ from cells in the second region by their volume ratios.

8. The article of footwear of claim 1, wherein the one or more of the outsole, the upper, and the mid-sole is the upper.

9. The article of footwear of claim 8, wherein the first region is one or more of a tip section of the outsole and a heel section of the outsole and the second region is a part of the outsole located between the tip section and the heel section, the first stiffness higher than the second stiffness.

10. The article of footwear of claim 1, further comprising an insole inside the foot-receiving cavity, the insole made with the lattice structure.

11.-20. (canceled)
